(19) United States
(12) Patent Application Publication
(10) Pub. No.: US 2024/0394469 A1
(43) Pub. Date: Nov. 28, 2024

(54) METHOD, APPARATUS AND ELECTRONIC DEVICE FOR DATA PROCESSING

(71) Applicant: Beijing Zitiao Network Technology Co., Ltd., Beijing (CN)

(72) Inventor: Zhijie ZHENG, Beijing (CN)

(21) Appl. No.: 18/674,767

(22) Filed: May 24, 2024

(30) Foreign Application Priority Data
May 25, 2023 (CN) 202310601787.6

(51) Int. Cl. G06F 40/177

(52) U.S. Cl. CPC G06F 40/177

(57) ABSTRACT

A method, apparatus and electronic device for data processing are provided. A specific implementation of the method comprises: obtaining a plurality of filtering conditions for filtering data in a data table and a logical relationship between the plurality of filtering conditions; determining a first numerical value corresponding to each filtering condition among the plurality of filtering conditions, wherein the first numerical value corresponding to a filtering condition is determined by at least one first record obtained according to the filtering condition; performing a logical operation based on the first numerical value and the logical relationship between the plurality of filtering conditions; and determining a record to generate a pivot table. The implementation can simplify the process of generating a pivot table and improve the speed of generating the pivot table.

### CROSS-REFERENCE TO RELATED APPLICATION

This application claims the benefit of Chinese Patent Application No. 202310601787.6 filed on May 25, 2023, entitled “METHOD, APPARATUS, DEVICE AND STORAGE MEDIUM FOR DATA PROCESSING”, which is hereby incorporated by reference in its entirety.

### FIELD

The present disclosure relates to the technical field of data processing, and in particular, to a method, apparatus and an electronic device for data processing.

### BACKGROUND

A pivot table is a table analysis tool for classifying and summarizing complex data. In addition to quickly performing calculations such as sums, counts, averages, etc., the pivot table can also display key data on demand. During generating the pivot table, data in a source data table needs to be filtered, for example, a union or intersection of records corresponding to one or more filtering conditions is calculated to obtain filtered records. However, in application scenarios with a huge size of the source data table, a large amount of calculation and a high complexity are usually required. Therefore, an efficient data processing method needs to be provided.

### SUMMARY

The present disclosure provides a method, apparatus and electronic device for data processing.

According to a first aspect, a method for data processing is provided, the method comprising:
obtaining a plurality of filtering conditions for filtering data in a data table and a logical relationship between the plurality of filtering conditions;
determining a first numerical value corresponding to each filtering condition among the plurality of filtering conditions, wherein the first numerical value corresponding to a filtering condition is obtained by converting a first binary number determined by at least one first record in the data table, and wherein the at least one first record is determined based on the filtering condition;
performing a logical operation based on the first numerical value and the logical relationship between the plurality of filtering conditions; and
determining a record based on a result of the logical operation, wherein the record is used for generating a pivot table.

According to a second aspect, an apparatus for data processing is provided, the apparatus comprising:
an obtaining module configured for obtaining a plurality of filtering conditions for filtering data in a data table and a logical relationship between the plurality of filtering conditions;
a processing module configured for determining a first numerical value corresponding to each filtering condition among the plurality of filtering conditions, wherein the first numerical value corresponding to a filtering condition is obtained by converting a first binary number determined by at least one first record in the data table, and wherein the at least one first record is determined based on the filtering condition;
the processing module configured for performing a logical operation based on the first numerical value and the logical relationship between the plurality of filtering conditions; and
the processing module configured for determining a record based on a result of the logical operation, wherein the record is used for generating a pivot table.

According to a third aspect, a computer readable storage medium is provided, storing a computer program thereon, the computer program, when executed in a computer, implementing a method according to any of the first aspect.

According to a fourth aspect, an electronic device is provided, comprising a memory, a processor and executable codes stored in the memory, the executable codes, when executed by the processor, implementing a method according to any of the first aspect.

The technical solutions provided by the embodiments of the present disclosure may have the following beneficial effects:

With the method and apparatus for data processing provided by the embodiments of the present disclosure, first, a plurality of filtering conditions for filtering data in a data table and a logical relationship between the plurality of filtering conditions are obtained, and a numerical value corresponding to each filtering condition among the plurality of filtering conditions is determined based on a binary number corresponding to a record determined by the each filtering condition. Then, a logical operation is performed on the numerical value corresponding to the filtering condition based on the logical relationship between the filtering conditions, so as to determine a record. Therefore, the process of generating the pivot table by re filtering the record determined based on the filtering condition is simplified. The solution can improve the speed of generating the pivot table with a higher data processing efficiency in application scenarios of with a huge size of source data tables.

It is to be understood that both the foregoing general description and the following detailed description are exemplary and explanatory only and are not intended to limit the present disclosure.

### BRIEF DESCRIPTION OF THE DRAWINGS

To describe the technical solutions in the embodiments of the specification more clearly, a brief introduction is presented below to the accompanying drawings required for describing the embodiments. Apparently, the accompanying drawings in the following description show merely some embodiments described in the specification, and those of ordinary skill in the art may further derive other drawings from these accompanying drawings without the exercise of any creative efforts.

FIG. 1 is a schematic diagram of a method for data processing in the related art shown in the present disclosure;

FIG. 2 is a flowchart of a method for data processing according to an embodiment of the present disclosure;

FIG. 3 is a flowchart of an algorithm for determining a binary number corresponding to a numerical interval according to an embodiment of the present disclosure;

FIG. 4 is a flowchart of an algorithm for decompressing a numerical value according to an embodiment of the present disclosure;

FIG. 5 is a block diagram of an apparatus for data processing according to an embodiment of the present disclosure;

FIG. 6 is a schematic block diagram of an electronic device according to some embodiments of the present invention;

FIG. 7 is a schematic block diagram of another electronic device according to some embodiments of the present invention; and

FIG. 8 is a schematic diagram of a storage medium according to some embodiments of the present disclosure.

### DETAILED DESCRIPTION

In order to enable those skilled in the art to better understand the technical solutions in this specification, a clear and complete description is presented below to the technical solutions in the embodiments of this description with reference to the accompanying drawings in the embodiments of the present specification. Apparently, the embodiments to be described are merely a part rather than all of the embodiments of this specification. All other embodiments obtained by those of ordinary skill in the art based on the embodiments in this specification without the exercise of any creative efforts shall belong to the protection scope of this specification.

When the following description refers to the accompanying drawings, unless otherwise indicated, the same numbers in different drawings represent the same or similar elements. The implementations described in the following exemplary embodiments do not represent all implementations consistent with the present disclosure. On the contrary, they are merely examples of the apparatus and method consistent with some aspects of the present disclosure as detailed in the appended claims.

The terminology used in the present disclosure is for the purpose of describing particular embodiments only and is not intended to limit the present disclosure. The singular forms “a/an”, “said” and “the” as used herein are intended to include the plural forms as well, unless clearly indicated otherwise in the context. It should further be understood that the term “and/or” as used herein refers to and encompasses any or all possible combinations of one or more associated listed items.

It should be understood that although the terms first, second, third and the like may be used in the present disclosure to describe various information, such information should not be limited by these terms. These terms are only used to distinguish the same type of information from each other. For example, first information may also be referred to as second information, and similarly, the second information may also be referred to as the first information, without departing from the scope of the present disclosure. The word “if” as used herein may be construed as “when” or “while” or “in response to determining,” depending on the context.

With the continuous development of computer technologies, more and more table processing class application products support a function of generating a pivot table. In order to enable the pivot table to access different services, the pivot table may be extracted into an independent module on the product side. Generally, the order numbers of the filtered records in the source data table will be saved using an ascending order number array on the product side. Then, the order number array is calculated by a data pivot table generating engine to obtain typesetting data, and each service can access the typesetting data to a respective view layer to facilitate users to perform further data processing.

In practical applications, the source data table is generally a two-dimensional table, for example, a field of the source data table is used as one dimension, and a record containing a field value of the field is recorded as another dimension. According to different user requirements, one record may include field values of one or more fields of the source data table, and an order number of one record may be a row number or a column number of the record in the source data table. For the sake of description, the solution proposed in the present disclosure will be described below by taking a field in the source data table as a column dimension and a record containing a field value of the field as a row dimension as an example. At this point, an order number of a record is the row number of the record in the source data table, and accordingly, when the field serves as the row dimension and the record including the field value of the field serves as the column dimension, similar operations may also be performed using the solution proposed in the present disclosure, so as to solve the same technical problem and achieve the same technical effect.

FIG. 1 shows a schematic diagram of a method for data processing in the related art.

As shown in FIG. 1, the source data table is initially filtered twice to obtain two order number arrays: an order number array A and an order number array B. The order number array A and the order number array B store different order numbers, which may be order numbers of records obtained by filtering the same field (e.g., city) of the source data table according to two different filtering conditions (e.g., city=shenzhen, city=hangzhou).

Order numbers 1, 3, 5, 6, 7, 8, 11, 12, and 25 are stored in the order number array A. The order number array A indicates that 9 records in the source data table are selected according to a first filtering condition (e.g., city=shenzhen), with row numbers in the source data table of 1, 3, 5, 6, 7, 8, 11, 12, and 25, respectively. Likewise, order numbers 2, 3, 5, 7, 10, 12, 14, 16 and 25 are stored in the order number array B. The order number array B indicates that 9 records in the source data table are selected according to a second filtering condition (e.g., city=hangzhou), with order numbers in the source data table of 2, 3, 5, 7, 10, 12, 14, 16 and 25 respectively. Each of the foregoing filtered records includes field values of a plurality of fields (such as city and country).

In order to generate a pivot table, two sets of required records are obtained in a source data table through preliminary filtering twice, and after order numbers corresponding to the records are stored in an order number array, the order number array needs to be calculating using a pivot table generating engine. The calculation may comprise: traversing the order number array A and the order number array B to find order number contained therein, and performing a union set on the order numbers contained in the order number array A and the order number array B to obtain an order number array C, i.e., performing a union set on rows where a filtering field value of a field (such as city) is located to obtain a filtering row of the field.

Order numbers 1, 2, 3, 5, 6, 7, 8, 10, 11, 12, 14, 16, and 25 are stored in the order number array C obtained by the union set calculation. The record corresponding to the order number may be determined according to 13 order numbers included in the order number array C. A pivot table of the user is generated according to a field value included in the record.

As described above, since order numbers are stored in a manner of ascending order number arrays, for two order number arrays including different order numbers, in order to perform a union operation of the order numbers, it is necessary to compare the order number array A with the order number array B and traverse the two arrays to find out different order numbers. If the process of generating the pivot table further needs to combine an order number array D (the process of generating the order number array D is similar to those of the order number arrays A and B), the foregoing process further needs to compare each two of the order number arrays A, B and D. It can be seen that, in this storage manner, the time complexity of generating the pivot table is O(2mn)=O(mn), and the space complexity is O(mn), wherein m is the quantity of the order numbers contained in the order number array, and n is the quantity of the order number arrays participating in the calculation.

It is not difficult to find that in application scenarios with a huge size of source data tables, such computation tasks often tend to be of extremely high complexity, making the generation of the pivot table slow and inefficient.

In view of this, the embodiments of the present disclosure provide a data processing solution First, a plurality of filtering conditions for filtering data in a data table and a logical relationship between the plurality of filtering conditions are obtained, and a numerical value corresponding to each of the plurality of filtering conditions is determined based on a binary number corresponding to a record determined by each filtering condition. Then, a logical operation is performed on the numerical value corresponding to the filtering condition based on the logical relationship between the filtering conditions, so as to determine a record. In this way, the process of generating the pivot table by refiltering the record determined based on the filtering condition is simplified. The solution can improve the speed of generating the pivot table with a higher data processing efficiency in application scenarios of with a huge size of source data tables.

A detailed description is presented below to a method, apparatus and electronic device of data processing provided in the embodiments of the present disclosure with reference to the foregoing content.

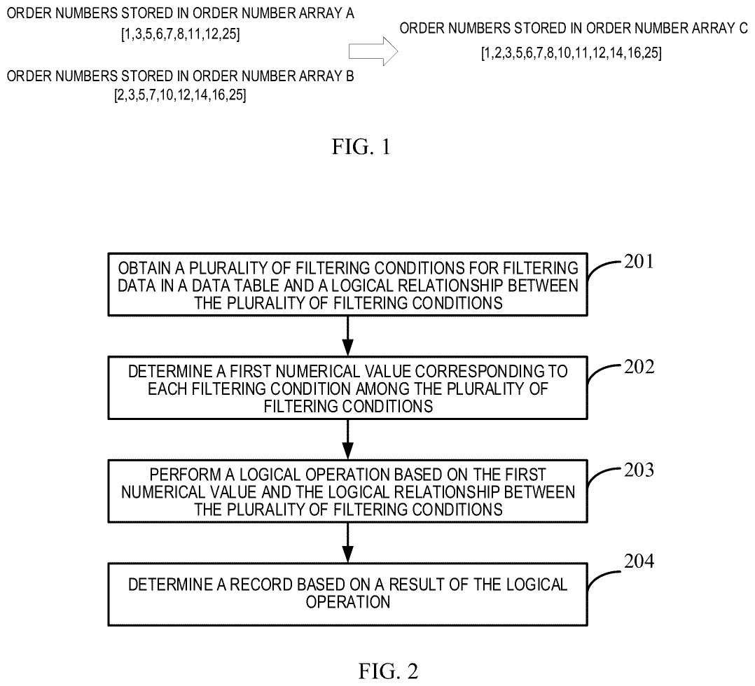

FIG. 2 shows a flowchart of a method of data processing provided by the embodiments of the present disclosure. A body implementing the method may be any device, platform, server or device cluster with calculation and processing capabilities. As shown in FIG. 2, the method mainly comprises:

At Step S201, obtaining a plurality of filtering conditions for filtering data in a data table and a logical relationship between the plurality of filtering conditions.

The data table can be a table created by manually adding data or connecting a database to download data. As an example, the user may set different filtering conditions to filter the data in the data table. Specifically, any field of the data table may be filtered by setting different conditions and using a logical relationship between the conditions as a filtering condition.

For example, for a field with a field value being a numerical value, a filtering condition for the field may be the magnitude of the field value or the range of the field value; For a field with a field value being text, a filtering condition for the field may be content, font and color of the text, or a condition obtained by combining these single conditions based on a set logical relationship. Depending on different user requirements, different filtering results can be obtained by filtering the data table based on the contents of the data table and in combination with different filtering conditions.

In an example, one or more fields that need to be filtered in the data table as well as individual filtering conditions for filtering one field multiple times or filtering each field separately may be determined in order to generate the pivot table.

In addition, a logical relationship between various filtering conditions also needs to be obtained, so that a generating engine of the pivot table can calculate, based on the logical relationship, an order number corresponding to a record determined according to each filtering condition once or multiple times, so as to obtain a record. Specifically, a logical operation of “bitwise AND” may be performed on the order number, so as to obtain intersection of filtering rows of different fields. Or a logical operation of “bitwise OR” may be performed on the order number, so as to obtain a union set of filtering rows of the same field.

At Step S202, determining a first numerical value corresponding to each of the plurality of filtering conditions, where the first numerical value corresponding to any filtering condition is obtained by converting a first binary number, the first binary number is determined by at least one first record in the data table, and the at least one first record is determined by the filtering condition.

The first record is a record obtained by filtering in the data table based on any of the plurality of filtering conditions. The first record has a corresponding order number in the data table. A first identifier corresponding to at least one first record may be determined based on any filtering condition, and an order number corresponding to the corresponding first record in the data table is determined based on the first identifier. For example, the first identifier may be an order number, and may also be a mark (English letter, Roman symbol, or the like) associated with the order number. The order number corresponding to the record obtained after filtering based on any filtering condition needs to be stored.

In this embodiment, the user side saves an order number corresponding to each of at least one first record in a manner of setting each first record to correspond to a digit in a binary number. Specifically, for each of the at least one first record, a digit in a binary number corresponding to the first identifier corresponding to each first record is determined. A first binary number is determined based on the digit in the binary number corresponding to each first identifier. A first numerical value is obtained by converting the first binary number. The first numerical value is stored at the user side, where the first numerical value includes an order number corresponding to a record obtained after filtering according to any filtering condition.

As an example, according to different user requirements, each first identifier may correspond to one or more binary bits in a corresponding binary number. Based on the foregoing content, the order number corresponding to the first record in the data table may be determined through each first identifier. If the user also needs to carry other information through each first identifier, each first identifier may be set to correspond to a plurality of binary bits in the corresponding binary number, and each binary bit is used to carry different information. In this embodiment, illustration is given where each first identifier corresponds to one binary bit in the corresponding binary number and the binary bit corresponds to an order number corresponding to the first record corresponding to each identifier. It can be understood that, when each first identifier corresponds to a plurality of binary bits in a corresponding binary number, similar operations may also be performed to achieve the same technical effect.

For a specific programming language, the first numerical value stored at the user side may be an integer or other data type. The binary number obtained by converting the first numerical value has a plurality of binary bits, each of which may correspond to at least one first identifier.

Therefore, at the user side, the order number of the at least one first record can be stored by storing a numerical value, and thus order numbers are stored in a compressed manner. As a result, the data storage efficiency at the user side can be improved and the memory overhead can be reduced.

For a specific programming language, the supported storage type may contain a fixed number of data storage bits. For example, for the JavaScript programming language, an integer may include 32 binary bits. When the data table has a large number of data cells (for example, 500 W data cells), the number of first records determined by filtering the data table based on any filtering condition may also be huge, which is far greater than the number of data storage bits included in a storage type supported by the programming language. Hence, a plurality of order numbers corresponding to a plurality of first records need to be stored in segments, and order numbers included in each segment correspond to a segment of a binary number.

In an implementation, a first identifier corresponding to at least one first record is determined for the at least one first record determined according to any filtering condition, and a bit of a binary number corresponding to the first identifier is represented in the segmented binary number. Each segment of the binary number may have the same or a different number of binary bits, resulting from a data conversion of an integer or other data type in programming language.

Specifically, the first value corresponding to any filtering condition is set to include at least one value, and the first binary number obtained by converting the first value includes at least one segment of binary number. Each value is obtained by converting a segment of binary number included in the first binary numeral, each segment of the binary number corresponds to a numerical interval, and the numerical interval indicates a numerical range of an order number corresponding to each first record determined according to a filtering condition.

Thus, by representing the digit of the binary number corresponding to the first identifier in the segmented binary number, the user side can save information of order numbers corresponding to any number of first records, thereby supporting more application scenarios.

At Step S203, performing a logical operation based on the first value and the logical relationship between the plurality of filtering conditions.

In this embodiment, at least one first record is determined from the data table based on each of the plurality of filtering conditions. The at least one first record may be an initial filtering result, rather than data to be eventually displayed in the pivot table. The generating engine of the pivot table requires one or more calculations based on the initial filtering result to determine the record. For example, a row where a filtering field value of each field is located is subjected to a union set operation to obtain a filtering row of the field, or filtering rows of all fields are subjected to an intersection operation to obtain a filtering row to be displayed in the pivot table. A pivot table is generated according to data for data analysis and processing by the user.

Specifically, at least one numerical value included in the respective first numerical values corresponding to the plurality of filtering conditions is determined, and a numerical value interval respectively corresponding to each numerical value and a segment of binary number respectively corresponding to each numerical value are determined. A bitwise logical operation is performed on binary numbers corresponding to the same numerical interval in the plurality of filtering conditions according to the logical relationship between the plurality of filtering conditions, to obtain a second numerical value. The second numerical value corresponds to a second binary number, and each of the at least one record corresponds to one digit in the second binary number.

Thus, order numbers corresponding to records obtained according to filtering conditions are stored in numerical values in a compressed manner, and then binary numbers corresponding to different numerical values are subjected to a bitwise logical operation, thereby increasing the speed of generating the pivot table and improving the data processing efficiency.

At Step S204, determining a record according to a result of the logical operation, where the record is used to generate a pivot table.

In this embodiment, the second numerical value is a result obtained according to the logical operation. By performing a decompression operation on the second numerical value, a record can be determined, and a pivot table is generated according to the record. Since the record is obtained by refiltering according to the first record in the at least one first record, the record also corresponds to a digit in the second binary number.

In one implementation, an order number of the record may be directly determined by decompressing the second numerical value. In another implementation, a second binary number corresponding to the second numerical value may be determined first, and then the second binary number is decompressed to determine the order number of the record.

The process of decompressing the second numerical value to obtain the order number corresponding to the contained record is opposite to the foregoing process of obtaining the first numerical value according to the order number corresponding to the record determined by the filtering condition.

Thus, by storing order numbers corresponding to records obtained according to filtering conditions in numerical values in a compressed manner, performing a bitwise logical operation on binary numbers corresponding to different numerical values, and finally decompressing a result of the logical operation, a record can be determined, thereby simplifying the process of generating a pivot table.

The solution proposed by the present disclosure will be schematically illustrated below with reference to a complete application instance.

An application scenario may be: in a computer or a human-machine interaction device, an application program for implementing the solution proposed in the present disclosure is written using a Tavascript programming language (TypeScript is an upgrade version based on JavaScript). The TavaScript programming language supports a storage mode of bit flags. Bit flags refer to an enumeration class implemented using bitwise operations, where enumeration items are incremented by powers of 2.

In the Tavascript programming language, when performing a bitwise operation on a numerical value, a double type is converted into a signed int32 type, and a part exceeding 31 bits (the highest bit is a sign bit) in the original numerical value is discarded. Therefore, data of an integer can only express 31-bit binary bits at most.

Table 1 shows a data table provided in an embodiment of the present disclosure. As shown in Table 1, Table 1 includes at least fields: id, country, city. The field id at least includes a field value ABCD, the field country at least includes a field value China, and the field city at least includes a field value shanghai. Order numbers corresponding to records containing these field values are labeled in Table 1.

TABLE 1

| Order | | | | | | |
|---|---|---|---|---|---|---|
| number | id | country | city | . . . | . . . | . . . |
| 0 | ABCD | China | shanghai | . . . | . . . | . . . |
| 1 | . . . | . . . | shanghai | . . . | . . . | . . . |
| 2 | ABCD | . . . | . . . | . . . | . . . | . . . |
| 3 | . . . | China | shanghai | . . . | . . . | . . . |
| 4 | ABCD | China | . . . | . . . | . . . | . . . |
| . . . | . . . | . . . | . . . | . . . | . . . | . . . |
| 31 | ABCD | . . . | . . . | . . . | . . . | . . . |
| 32 | ABCD | . . . | . . . | . . . | . . . | . . . |
| . . . | . . . | . . . | . . . | . . . | . . . | . . . |
| 34 | ABCD | . . . | . . . | . . . | . . . | . . . |
| . . . | . . . | . . . | . . . | . . . | . . . | . . . |
| 62 | . . . | China | shanghai | . . . | . . . | . . . |
| . . . | . . . | . . . | . . . | . . . | . . . | . . . |
| 64 | . . . | China | . . . | . . . | . . . | . . . |
| 65 | . . . | . . . | shanghai | . . . | . . . | . . . |
| 66 | . . . | China | shanghai | . . . | . . . | . . . |
| . . . | . . . | . . . | . . . | . . . | . . . | . . . |

According to the user requirement, for the three fields id, country, city in the data table, three obtained filtering conditions are respectively id=ABCD, country=China, city=shanghai, and a logical relationship of “bitwise AND” exists between the three filtering conditions. In this embodiment, based on numerical values respectively corresponding to the three filtering conditions and the logical operation relationship “bitwise AND” between the filtering conditions, an intersection set is obtained for rows in which the filtering field values obtained by filtering according to the three filtering conditions are located.

According to the above step S202, a first numerical value corresponding to each of the plurality of filtering conditions is determined next. The first value comprises at least one value, and a first binary number obtained by converting the first value comprises at least one segment of binary number. Each value is obtained by converting a segment of binary number included in the first binary number, each segment of the binary number corresponds to a numerical interval, and the numerical interval indicates a numerical range of an order number corresponding to each first record determined according to the filtering condition.

As shown in Table 1, order numbers corresponding to the records determined according to the three filtering conditions are 0, 2, 4, 31, 32, 34, 0, 3, 4, 62, 64, 66, 0, 1, 3, 62, 65, and 66, respectively. It is necessary to determine a numerical interval of the order numbers according to the magnitude of the order number values of these order numbers, determine a segment of binary number corresponding to the numerical interval, and convert the corresponding numerical value according to the segment of binary number.

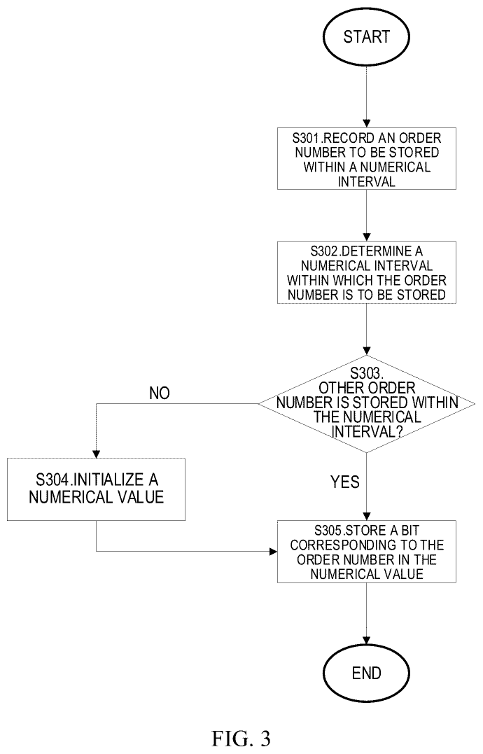

FIG. 3 shows a flowchart of an algorithm for determining a binary number corresponding to a numerical interval provided by an embodiment of the present disclosure. As shown in FIG. 3, the algorithm is implemented based on a Tavascript programming language. An order number in the numerical interval is converted into a binary number by means of a left shift (<<) operation, and then these binary numbers are subjected to a “bitwise OR” logical operation to obtain binary numbers, which mainly comprises the following:

At Step S301: recording an order number in a numerical interval which needs to be stored.

For example, an order number that needs to be stored in the numerical interval is recorded as row.

At Step S302, determining a numerical interval in which the order number is to be stored.

In an example, a remainder operation may be performed on the order number to determine a numerical interval in which the order number is to be stored. Taking TypeScript as an example, it may be expressed as follows: let offset=row % 31, startRow=row-offset, where offset is a value obtained by means of a remainder operation, and startRow is a starting order number of a numerical interval in which the order number is to be stored.

At Step S303, determining whether other order numbers are stored in the numerical interval.

In an example, a numerical value corresponding to the numerical interval in which the order number lies may be set as fieldIndex Map Value.

If the judgment result is no, the flow proceeds to step S304 to initialize the numerical value fieldIndex Map Value to 0, and then the flow proceeds to step S305.

If the judgment result is yes, the flow proceeds to step S305 to store the digit corresponding to the order number into the numerical value.

In an example, by performing a “bitwise OR” operation on 1<<offset and fieldIndexMapValue[startRow], and the digit corresponding to the order number is stored in the numerical value.

The algorithm shown in FIG. 3 is described by taking order numbers 0, 2, 4, 31, 32, and 34 corresponding to the records determined by filtering according to the filtering condition id=ABCD as an example.

A corresponding numerical interval is determined according to the magnitude of the serial value of each of the order numbers 0, 2, 4, 31, 32 and 34. The order numbers 0, 2 and 4 are stored in a first numerical interval (the order numbers with the serial values ∈ (0˜31) correspond to a numerical interval), the order numbers 31, 32 and 34 are stored in a second numerical interval (the order numbers with the serial values ∈ (32˜63) correspond to a numerical interval), and so on for other order numbers if there are any.

For each numerical interval, a corresponding segment of binary numbers may be determined according to the following algorithm.

The order numbers 0, 2 and 4 are respectively converted into three binary numbers by means of a left shift (<<) operation, and a binary number with a certain length (the length is 32 bits, and the default total is a positive number, and the highest sign bit is 0) can be obtained by left shifting the binary number of a decimal 1 to 0, 2 and 4 bits respectively to represent the included order number, which is specifically represented as follows:
1<<0=0000 0000 0000 0000 0000 0000 0001,
1<<2=0000 0000 0000 0000 0000 0000 0000 0100,
1<<4=0000 0000 0000 0000 0000 0001 0000,
For these three binary numbers, they are subjected to a bitwise OR logical operation to obtain a binary number that expresses their summary results:
1<<0 | 1<<2 | 1<<4=0000 0000 0000 0000 0000 0000 0001 0101,
It can be seen from the above that, a segment of binary numbers corresponding to the first numerical interval is 0000000 0000 0000 0000 0000 000010101. The segment of binary numbers is converted into a decimal number 21, and the obtained decimal number is used as the numerical value corresponding to the segment of binary numbers.

Likewise, by performing operations on the order numbers 31, 32, and 34 according to the algorithm shown in FIG. 3, it may be determined that a segment of binary numbers corresponding to the second numerical interval is 0000 0000 0000 0000 0000 0000 1011, and the numerical value determined according to the segment of binary numbers is 31.

At the user side, the plurality of numerical intervals and numerical values corresponding to the numerical intervals are stored.

In one implementation, the plurality of generated numerical values may be stored in an array manner. In some application scenarios in which order numbers filtered according to the filtering condition are sparsely distributed, there may be a large number of empty numerical intervals, that is, a numerical value determined according to an order number corresponding to the numerical interval is 0. In order to carry information about numerical intervals corresponding to a plurality of numerical values, a large number of numerical values of empty numerical intervals need to be stored. For example, order numbers obtained by filtering are 0, 30999, and 61999, values are stored using an array, and an array with a length of 2000 (calculate 61999/31≈1999.97, which is then rounded up) may be obtained. Compared with an order number array [0, 30999, 61999] in which the number of array elements before optimization is 3, the memory storage will be degraded instead.

In another implementation, the plurality of generated values are stored in a map manner. A structure of a map is set as: key: value. Taking order numbers 0, 2, 4, 31, 32 and 34 determined according to the filtering condition that id=ABCD as an example, in a bit flags structure of the TypeScript programming language, the map saved is: 0: 21, 31:11, wherein 0 and 31 are key values of the map that represent a starting order number of a numerical interval, and 21 and 11 are values of the map that represent numerical values obtained by converting segmented binary numbers.

In an application scenario in which order numbers are sparsely distributed, although the map needs to additionally store the starting order number key of the numerical interval besides the plurality of numerical values, compared with an array-based storage manner, the map-based storage manner results in more stable memory usage performance.

Taking order numbers 0, 2, 4, 31, 32, and 34 as an example, in the order number array shown in FIG. 1, six integer array elements need to be used. In the bit flags structure with map, there are four integer data for storing the starting order number of the numerical interval and the numerical value corresponding to the numerical interval. In general, the map-based bit flags structure enables the memory overhead to be optimized to

$$\frac{1}{j} ( \frac{1}{2} <= j <= \frac{31}{2} )$$

of the original size. In this example, the denominator 6 represents that the order number array includes six integer array elements, and the numerator 4 represents that four integer data needs to be occupied to store a starting order number of a numerical interval and a value corresponding to the numerical interval.

The numerical value set determined according to the foregoing content may be expressed as:

```
TypeScript
{
  id: {
    0: 21, // 21 = 1 << 0 | 1 << 2 | 1 << 4
    31: 11, // 11 = 1 << 31-31 | 1 << 32-31 | 1 << 34-31,
  },
  country: {
    0: 25, // 25 = 1 << 0 | 1 << 3 | 1 << 4
    62: 21, // 21 = 1 << 62-62 | 1 << 64-62 | 1 << 66-62
  },
  city: {
    0: 11, // 11 = 1 << 0 | 1 << 1 | 1 << 3
    62: 25, // 11 = 1 << 62-62 | 1 << 65-62 | 1 << 66-62
  }
}
```

In the numerical value set, taking the filtering condition id=ABCD as an example, the first numerical value of the filtering condition includes two numerical values 21 and 11. Each numerical value corresponds to a numerical interval.

A logical operation is performed according to the first numerical value corresponding to the three filtering conditions included in the numerical value set and the logical relationship between the three filtering conditions.

numerical value sets of two filtering conditions id=ABCD and country=China are traversed first, and numerical values within the same numerical interval (0) are subjected to a “bitwise AND” operation to calculate an intersection set. A new numerical value set is obtained, which may be expressed as:

TypeScript
{
0: 17, // 17 = 21 & 25
}

Then, the filtering condition city=shanghai and the new numerical value set are traversed, and numerical values within the same numerical interval (0) are subjected to a “bitwise AND” operation to obtain a final numerical value set, which may be expressed as:

TypeScript
{
0: 1, // 1 = 17 & 11
}

The numerical value in the above-generated numerical value set is the second value. In the above numerical value set, there is only one numerical interval (0), and the numerical value corresponding to the numerical interval is 1. The second value may include only one of the values described above.

In this embodiment, order numbers of the records obtained by filtering according to the three filtering conditions are 0, 2, 4, 31, 32, 34, 0, 3, 4, 62, 64, 66, 0, 1, 3, 62, 65, and 66. In the order number array shown in FIG. 1, 18 integer array elements need to be used. In the map-based bit flags structure, 12 integer data need to be used to respectively store the numerical interval and the value corresponding to the numerical interval. If a map-based bit flags structure is used for compressed storage, the compression efficiency is

$$k = \frac{18}{12} .$$

The performance of performing a logical operation according to a logical relationship between a plurality of filtering conditions can be optimized as 1/k (k is the compression efficiency of an order number) of the original, i.e., the time complexity is optimized to O(mn/k), 1/k of the original.

Since the order numbers obtained by filtering are compressed and stored, the calculation algorithm executed by the generating engine of the pivot table also needs to be adjusted. A decompression operation needs to be performed on the second numerical value to determine records corresponding to order numbers included in the second numerical value.

In one implementation, the decompression of the numerical value is implemented by repeating the following steps until the numerical value is 0. For a specific numerical value, in the most complex case, the numerical value is repeatedly executed 31 times in order to determine an order number corresponding to each bit of a segment of binary bits corresponding to the numerical value.

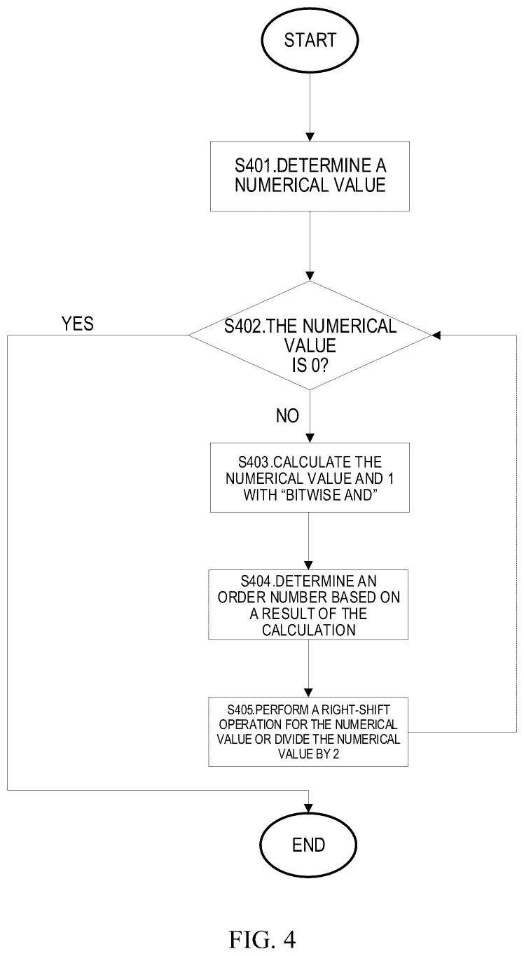

FIG. 4 shows a flowchart of an algorithm for decompressing a numerical value according to an embodiment of the present disclosure. As shown in FIG. 4, the algorithm mainly comprises the following:

At Step S401, determining a numerical value.

At Step S402, determining whether the numerical value is 0 or not.

If not, step S403 is performed, where for the current ith operation, the numerical value and 1 are subjected to “bitwise AND” calculation.

At Step S404, determining an order number according to the calculation result in step S403. If the result is 1, it indicates that the numerical value includes the ith row. otherwise, the ith row is not included.

At Step S405, right-shifting the numerical value by one bit (>>1) or dividing the numerical value by 2, and jumping to step S402.

If yes, the program ends.

Taking the TypeScript programming language as an example, the encoding implementation process may be expressed as:

```
TypeScript
const map = {
  0: 280593,
  31: 1073742336,
}
// set
let rowlist = [ ];
// set current numerical value
let i = 0; // map[0] = 280593
let num = 280593;
while(num) {
  if (num & 1 == 1) { // bitwise AND
    rowlist.push(i)
  }
  i++;
  num = num >> 1; // or num = num / 2;
}
```

In another implementation, the numerical value may be first converted into a binary string, and then the binary string is traversed. The implementation principle is similar to that in the foregoing first implementation. If the ith character is 1, it indicates that the numerical value includes the ith row.

Taking the TypeScript programming language as an example, the encoding implementation process may be expressed as:

```
TypeScript
const map = {
  0: 280593,
  31: 1073742336,
}
// set
let rowlist = [ ];
// set current numerical value
let i = 0;
const num = map[0]; // map[0] = 280593
// value converted to binary
let binNum = num.toString(2); // 280593 => 1000100100000010001
while(binNum) {
  if (binNum & 1 == 1) { // bitwise AND
    rowlist.push(i)
  }
  i++;
  binNum = binNum >> 1; // [symbol]   binNum = binNum / 2;
}
```

In the foregoing two implementations, the time complexity is both O(i), where i is the maximum order number included in the numerical value.

It should be noted that although the operations of the methods of the embodiments of the present disclosure have been described in the above embodiments in a particular order, this does not require or imply that these operations shall be performed in that particular order or that all illustrated operations shall be performed in order to achieve the desired results. On the contrary, the steps depicted in the flowcharts may change the order of execution. Additionally or alternatively, certain steps may be omitted, a plurality of steps combined into one step for execution, and/or one step decomposed into a plurality of steps for execution.

Corresponding to the foregoing data processing method embodiments, the present disclosure further provides embodiments of a data processing apparatus.

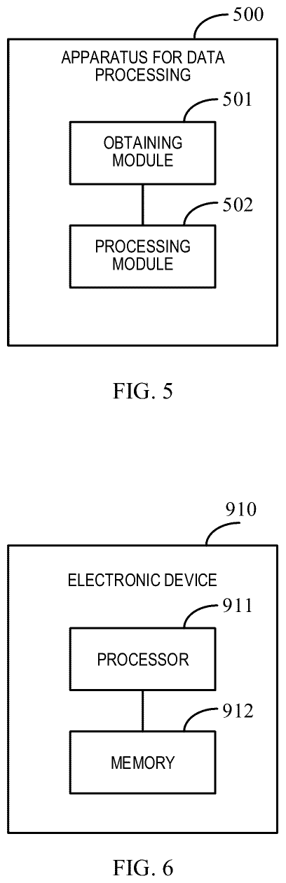

FIG. 5 shows a block diagram of an apparatus for data processing according to an embodiment of the present disclosure. As shown in FIG. 5, the apparatus 500 may comprise: an obtaining module 501 and a processing module 502.

The obtaining module 501 is configured for obtaining a plurality of filtering conditions for filtering data in a data table and a logical relationship between the plurality of filtering conditions.

The processing module 502 is configured for determining a first numerical value corresponding to each filtering condition among the plurality of filtering conditions, where the first numerical value corresponding to any filtering condition is obtained by converting a first binary number, the first binary number is determined by at least one first record in the data table, and the at least one first record is determined according to the filtering condition.

The processing module 502 is further configured for performing a logical operation based on the first numerical value and the logical relationship between the plurality of filtering conditions.

The processing module 502 is further configured for determining a record according to a result of the logical operation, where the record is for generating a pivot table.

In some implementations, the filtering condition is a filtering condition for any field of the data table.

In some implementations, each first record in the at least one first record corresponds to one bit in the first binary number.

In some implementations, for each filtering condition among the plurality of filtering conditions, the processing module 502 determines a first numerical value corresponding to the filtering condition in the following manner:
determining a first identifier respectively corresponding to at least one first record satisfying the filtering condition in the data table;
determining the first binary number according to the first identifier respectively corresponding to the at least one first record; and
obtaining the first numerical value by converting the first binary number.

In some implementations, the processing module 502, when determining the first binary number according to the first identifier respectively corresponding to the at least one first record, is configured for:
determining a bit in a binary number respectively corresponding to each of the first identifiers; and
determining the first binary number according to the bit in the binary number respectively corresponding to each of the first identifiers.

In some implementations, for any filtering condition, a first numerical value corresponding to the filtering condition comprises at least one numerical value, and a first binary number obtained by converting the first numerical value comprises at least one segment of binary numbers.

Each numerical value is obtained by converting a segment of binary numbers comprised in the first binary number, each segment of the binary numbers corresponds to a numerical interval, and the numerical interval indicates a numerical range of an order number corresponding to each first record determined according to the filtering condition.

In some implementations, the processing module 502, when performing the logical operation based on the first numerical value and the logical relationship between the plurality of filtering conditions, is configured for:
determining at least one numerical value comprised in the first numerical values respectively corresponding to the plurality of filtering conditions;
determining a numerical interval respectively corresponding to each numerical value and a segment of binary numbers respectively corresponding to each numerical value; and
performing a bitwise logical operation on binary numbers corresponding to the same numerical interval in the plurality of filtering conditions according to the logical relationship between the plurality of filtering conditions.

In some implementations, the processing module 502, when determining the record according to the result of the logical operation, is configured for:
determining a second binary number corresponding to the result of the logical operation, where the second binary number corresponds to at least one record in the data table; and
determining the record according to the second binary number.

In some implementations, each record in the at least one record corresponds to one bit in the second binary number.

For the apparatus embodiment, since it basically corresponds to the method embodiment, related parts may be referred to the partial description of the method embodiment. The apparatus embodiments described above are merely exemplary, where units described as separate components may or may not be physically separate, and components displayed as units may or may not be physical units, i.e., may be located in one location, or may be distributed on a plurality of network units. Some or all of the modules may be selected according to actual needs to achieve the objectives of the embodiments of the present disclosure. Those of ordinary skill in the art can understand and implement the present invention without creative efforts.

FIG. 6 is a schematic block diagram of an electronic device provided by some embodiments of the present disclosure. As shown in FIG. 6, the electronic device 910 includes a processor 911 and a memory 912, which may be configured to implement a client or a server. The memory 912 is for non-transitory storage of computer-executable instructions (such as one or more computer program modules). The processor 911 is configured to run the computer executable instructions which, when run by the processor 911, can execute one or more steps of the above-described data processing method, thereby implementing the above-described data processing method. The memory 912 and the processor 911 may be interconnected via a bus system and/or other form of connection mechanism (not shown).

The processor 911 may be, for example, a central processing unit (CPU), a graphics processing unit (GPU), or other form of processing unit having data processing capabilities and/or program execution capabilities. For example, the central processing unit (CPU) may be an X86 or ARM architecture, etc. The processor 911 may be a general-purpose processor or a dedicated processor that can control other components in the electronic device 910 to perform desired functions.

For example, the memory 912 may include any combination of one or more computer program products that may include various forms of computer-readable storage media, such as volatile memory and/or non-volatile memory. The volatile memory may include, for example, a random access memory (RAM) and/or a cache, etc. The non-volatile memory may include, for example, a read only memory (ROM), a hard disk, an erasable programmable read only memory (EPROM), a portable compact disc read only memory (CD-ROM), a USB memory, a flash memory, etc. One or more computer program modules may be stored in the computer readable storage medium, and the processor 911 may run the one or more computer program modules to implement various functions of the electronic device 910. The computer readable storage medium may further store various application programs and various data, and various data used and/or generated by the application programs, and the like.

It should be noted that, in the embodiments of the present disclosure, for specific functions and technical effects of the electronic device 910, reference may be made to the foregoing description of the data processing method, and details are not repeated herein.

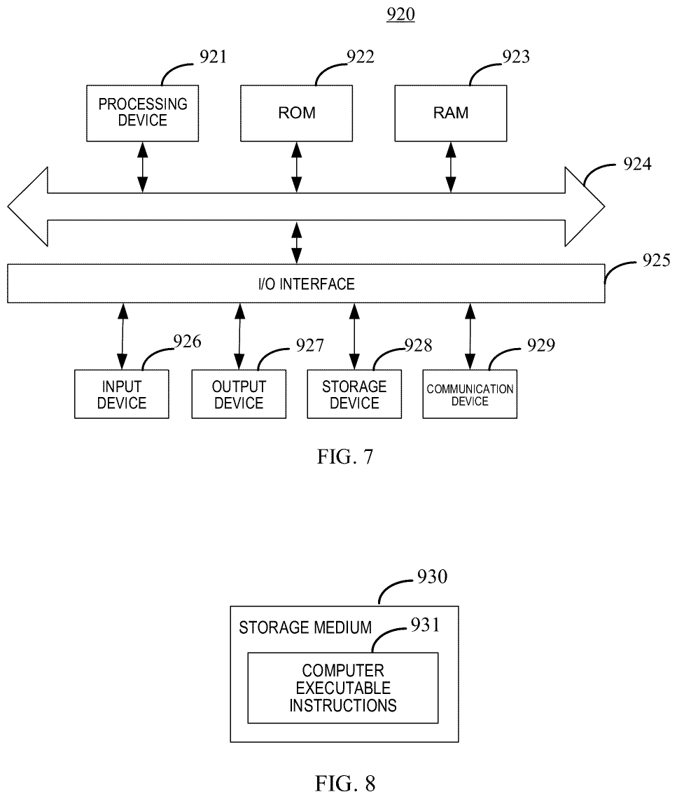

FIG. 7 is a schematic block diagram of another electronic device according to some embodiments of the present invention. The electronic device 920 is, for example, applicable to implement a data processing method provided by an embodiment of the present disclosure. The electronic device 920 may be a terminal device or the like, and may be used to implement a client or a server. The electronic device 920 may include, but is not limited to, a mobile terminal such as a mobile phone, a notebook computer, a digital broadcast receiver, a PDA (personal digital assistant), a PAD (portable Android device), a PMP (portable multimedia player), an on-board terminal (e.g., an on-board navigation terminal), a wearable terminal device and the like, and a fixed terminal such as digital TV, a desktop computer, a smart home device and the like. The electronic device 920 shown in FIG. 7 is merely an example and should not be construed as bringing any restriction on the functionality and usage scope of the embodiments of the present disclosure.

As shown in FIG. 7, the electronic device 920 may comprise a processing device (e.g., a central processor, a graphics processor) 921 which is capable of performing various appropriate actions and processes in accordance with programs stored in a read only memory (ROM) 922 or programs loaded from a storage device 928 to a random access memory (RAM) 923. In the RAM 923, there are also stored various programs and data required by the electronic device 920 when operating. The processing device 921, the ROM 922 and the RAM 923 are connected to one another via a bus 924. An input/output (I/O) interface 925 is also connected to the bus 924.

Usually, the following devices may be connected to the I/O interface 925: an input device 926 including a touch screen, a touch pad, a keyboard, a mouse, a camera, a microphone, an accelerometers, a gyroscope, or the like; an output device 927, such as a liquid-crystal display (LCD), a loudspeaker, a vibrator, or the like; a storage device 928, such as a magnetic tape, a hard disk or the like; and a communication device 929. The communication device 929 allows the electronic device to perform wireless or wired communication with other device so as to exchange data with other device. While FIG. 7 shows the electronic device 920 with various devices, it should be understood that it is not required to implement or have all of the illustrated devices. Alternatively, more or less devices may be implemented or exist.

Specifically, according to the embodiments of the present disclosure, the data processing method may be implemented as computer software programs. For example, the embodiments of the present disclosure comprise a computer program product that comprises a computer program embodied on a non-transitory computer-readable medium, the computer program including program codes for executing the data processing method shown in the flowchart. In such an embodiment, the computer program may be loaded and installed from a network via the communication device 929, or installed from the storage device 928, or installed from the ROM 922. The computer program, when executed by the processing device 921, perform the above functions defined in the data processing method of the embodiments of the present disclosure.

FIG. 8 is a schematic diagram of a storage medium provided by some embodiments of the present disclosure. For example, as shown in FIG. 8, a storage medium 930 may be a non-transitory computer readable storage medium for storing non-transitory computer executable instructions 931. The non-transitory computer-executable instructions 931, when executed by the processor, may implement the data processing method according to the embodiments of the present disclosure. For example, the non-transitory computer-executable instructions 931, when executed by the processor, may perform one or more steps of the data processing method described above.

For example, the storage medium 930 may be applied to the foregoing electronic device. For example, the storage medium 930 may include a memory in the electronic device.

For example, the storage medium may include a memory card of a smartphone, a storage component of a tablet computer, a hard disk of a personal computer, a random access memory (RAM), a read-only memory (ROM), an erasable programmable read-only memory (EPROM), a portable compact disc read-only memory (CD-ROM), a flash memory, or any combination of the foregoing storage media, and may also be another applicable storage medium.

For example, for description of the storage medium 930, reference may be made to the description of the memory in the embodiment of the electronic device, and details are not repeated herein. For specific functions and technical effects of the storage medium 930, reference may be made to the foregoing description of the data processing method, and details are not repeated herein.

It is noteworthy that the computer readable medium in the context of the present disclosure may be a tangible medium that can contain or store a program for use by or in connection with an instruction execution system, apparatus, or device. The computer readable medium can be a computer readable signal medium, a computer readable storage medium or any combination thereof. The computer readable storage medium may be, for example, but is not limited to, an electronic, magnetic, optical, electromagnetic, infrared or semiconductor system, apparatus or device, or any combination of the foregoing. More specific examples of the computer readable storage medium may include, without limitation to, the following: an electrical connection with one or more conductors, a portable computer diskette, a hard disk, a random access memory (RAM), a read-only memory (ROM), an erasable programmable read-only memory (EPROM or flash memory), an optical fiber, a portable compact disc read-only memory (CD-ROM), an optical storage device, a magnetic storage device, or any suitable combination of the foregoing. In the present disclosure, the computer readable storage medium may be any tangible medium containing or storing a program which may be used by an instruction executing system, apparatus or device or used in conjunction therewith. In the present disclosure, the computer readable signal medium may include a data signal propagated in baseband or as part of a carrier wave, with computer readable program code carried therein. The data signal propagated as such may take various forms, including without limitation to, an electromagnetic signal, an optical signal or any suitable combination of the foregoing. The computer readable signal medium may further be any other computer readable medium than the computer readable storage medium, which computer readable signal medium may send, propagate or transmit a program used by an instruction executing system, apparatus or device or used in conjunction with the foregoing. The program code included in the computer readable medium may be transmitted using any suitable medium, including without limitation to, an electrical wire, an optical fiber cable, RF (radio frequency), etc., or any suitable combination of the foregoing.

Other implementation solutions of the disclosure will be readily apparent to those skilled in the art from consideration of the description and practice of the invention disclosed herein. The present disclosure is intended to cover any variations, uses, or adaptations of the disclosure that follow the general principles of the disclosure and include common knowledge or customary technical means in the art to which this disclosure does not disclose. The specification and embodiments are considered as exemplary only, with a true scope and spirit of the disclosure being indicated by the following claims.

It should be understood that the present disclosure is not limited to the precise structures that have been described above and shown in the accompanying drawings, and that various modifications and changes may be made without departing from the scope thereof. The scope of the present disclosure is limited only by the appended claims.

What is claimed is:

1. A method for data processing, the method comprising:
obtaining a plurality of filtering conditions for filtering data in a data table and a logical relationship between the plurality of filtering conditions;
determining a first numerical value corresponding to each filtering condition among the plurality of filtering conditions, wherein the first numerical value corresponding to a filtering condition is obtained by converting a first binary number determined by at least one first record in the data table, and wherein the at least one first record is determined based on the filtering condition;
performing a logical operation based on the first numerical value and the logical relationship between the plurality of filtering conditions; and
determining a record based on a result of the logical operation, wherein the record is used for generating a pivot table.

2. The method of claim 1, wherein the filtering condition is a filtering condition for a field of the data table.

3. The method of claim 1, wherein each first record in the at least one first record corresponds to one bit in the first binary number.

4. The method of claim 1, wherein the first numerical value corresponding to a filtering condition for each filtering condition among the plurality of filtering conditions is determined by:
determining respective first identifiers corresponding to at least one first record satisfying the filtering condition in the data table;
determining the first binary number based on the respective first identifiers corresponding to the at least one first record; and
obtaining the first numerical value by converting the first binary number.

5. The method of claim 4, wherein the determining the first binary number based on the respective first identifiers corresponding to the at least one first record comprises:
determining bits in respective binary numbers corresponding to each of the first identifiers; and
determining the first binary number based on the bits in the respective binary numbers corresponding to each of the first identifiers.

6. The method of claim 1, wherein a first numerical value corresponding to a filtering condition comprises at least one numerical value, and a first binary number obtained by converting the first numerical value comprises at least one segment of binary numbers;
wherein each numerical values is obtained by converting a segment of binary numbers comprised in the first binary number and each segment of the binary numbers corresponds to a numerical interval representing a numerical range of an order number corresponding to each first record determined based on the filtering condition.

7. The method of claim 6, wherein the performing the logical operation based on the first numerical value and the logical relationship between the plurality of filtering conditions comprises:
determining at least one numerical value comprised in the respective first numerical values corresponding to the plurality of filtering conditions;
determining respective numerical intervals corresponding to each numerical value and respective segments of binary numbers corresponding to each numerical value; and
performing, based on the logical relationship between the plurality of filtering conditions, a bitwise logical operation on binary numbers corresponding to a same numerical interval in the plurality of filtering conditions.

8. The method of claim 1, wherein the determining the record based on the result of the logical operation comprises:
determining a second binary number corresponding to the result of the logical operation, wherein the second binary number corresponds to at least one record in the data table; and
determining the record based on the second binary number.

9. The method of claim 8, wherein each record in the at least one record corresponds to a bit in the second binary number.

10. An electronic device, comprising:
one or more processing device;
storage means, configured for storing one or more programs;
the one or more programs, when executed by the one or more processing device, causing the one or more processing device to perform a method comprising:
obtaining a plurality of filtering conditions for filtering data in a data table and a logical relationship between the plurality of filtering conditions;
determining a first numerical value corresponding to each filtering condition among the plurality of filtering conditions, wherein the first numerical value corresponding to a filtering condition is obtained by converting a first binary number determined by at least one first record in the data table, and wherein the at least one first record is determined based on the filtering condition;
performing a logical operation based on the first numerical value and the logical relationship between the plurality of filtering conditions; and
determining a record based on a result of the logical operation, wherein the record is used for generating a pivot table.

11. The device of claim 10, wherein the filtering condition is a filtering condition for a field of the data table.

12. The device of claim 10, wherein each first record in the at least one first record corresponds to one bit in the first binary number.

13. The device of claim 10, wherein the first numerical value corresponding to a filtering condition for each filtering condition among the plurality of filtering conditions is determined by:
determining respective first identifiers corresponding to at least one first record satisfying the filtering condition in the data table;
determining the first binary number based on the respective first identifiers corresponding to the at least one first record; and
obtaining the first numerical value by converting the first binary number.

14. The device of claim 13, wherein the determining the first binary number based on the respective first identifiers corresponding to the at least one first record comprises:
determining bits in respective binary numbers corresponding to each of the first identifiers; and
determining the first binary number based on the bits in the respective binary numbers corresponding to each of the first identifiers.

15. The device of claim 10, wherein a first numerical value corresponding to a filtering condition comprises at least one numerical value, and a first binary number obtained by converting the first numerical value comprises at least one segment of binary numbers;
wherein each numerical values is obtained by converting a segment of binary numbers comprised in the first binary number and each segment of the binary numbers corresponds to a numerical interval representing a numerical range of an order number corresponding to each first record determined based on the filtering condition.

16. The device of claim 15, wherein the performing the logical operation based on the first numerical value and the logical relationship between the plurality of filtering conditions comprises:
determining at least one numerical value comprised in the respective first numerical values corresponding to the plurality of filtering conditions;
determining respective numerical intervals corresponding to each numerical value and respective segments of binary numbers corresponding to each numerical value; and
performing, based on the logical relationship between the plurality of filtering conditions, a bitwise logical operation on binary numbers corresponding to a same numerical interval in the plurality of filtering conditions.

17. The device of claim 10, wherein the determining the record based on the result of the logical operation comprises:
determining a second binary number corresponding to the result of the logical operation, wherein the second binary number corresponds to at least one record in the data table; and
determining the record based on the second binary number.

18. The device of claim 17, wherein each record in the at least one record corresponds to a bit in the second binary number.

19. A computer readable medium, having a computer program stored thereon, the computer program, when executed by processing device, performing a method comprising:
obtaining a plurality of filtering conditions for filtering data in a data table and a logical relationship between the plurality of filtering conditions;
determining a first numerical value corresponding to each filtering condition among the plurality of filtering conditions, wherein the first numerical value corresponding to a filtering condition is obtained by converting a first binary number determined by at least one first record in the data table, and wherein the at least one first record is determined based on the filtering condition;
performing a logical operation based on the first numerical value and the logical relationship between the plurality of filtering conditions; and
determining a record based on a result of the logical operation, wherein the record is used for generating a pivot table.
